(19) United States
(12) Patent Application Publication
(10) Pub. No.: US 2014/0231111 A1
(43) Pub. Date: Aug. 21, 2014

(54) POWER TOOL WITH FLUID BOOST

(71) Applicant: STANLEY BLACK & DECKER, INC., New Britain, CT (US)

(72) Inventors: Mark LEHNERT, Westerville, OH (US); Gualberto JARDELEZA, Westerville, OH (US)

(73) Assignee: STANLEY BLACK & DECKER, INC., New Britain, CT (US)

(21) Appl. No.: 13/790,833

(22) Filed: Mar. 8, 2013

Related U.S. Application Data
(60) Provisional application No. 61/765,378, filed on Feb. 15, 2013.

(51) Int. Cl. B23Q 5/06; B25F 5/00

(52) U.S. Cl. CPC B23Q 5/06; B25F 5/00; B23Q 2005/005
USPC 173/1; 173/221; 29/402.01

(57) ABSTRACT

A power tool includes a fluidically-driven prime mover controlled by a multi-stage, throttle-actuated dual-ported mechanism disposed in the power tool. When the first stage is actuated, pressurized fluid is admitted into the prime mover via a first delivery path in fluid communication with one of the ports. When the second stage is actuated, pressurized fluid is also admitted into the prime mover via a second delivery path in fluid communication with the other port to augment the volume of pressurized fluid admitted into the prime mover via the first delivery path. In one embodiment of the present invention, the prime mover includes a dual-chamber air motor. Upon detecting an imminent stall condition, an operator can axially advance a trigger stem to admit a boost of pressurized air into the motor via the second delivery path.

### FIELD OF THE INVENTION

The present invention relates to fluidically-driven power tools, and more particularly to a power tool driven by an air motor.

### BACKGROUND OF THE INVENTION

Fluidically-driven prime movers are used to drive a variety of output members, whether powered by air, water or other fluid. Power tools using prime movers driven by pressurized air use for example reciprocating systems for driving impact mechanisms, and rotary motors for drilling, screwdriving, sawing, and the like. However, the utility of an air-powered tool is often limited by the availability and size of supplies of pressurized air.

Another difficulty is that conventional air-powered power tools use single-chamber rotary air motors. Such a power tool has a no-load output speed at the drill bit of about 23,000 rpm at about 10 inch pounds of torque. A glance at the speed/torque curve of a conventional air-driven drill will illustrate how quickly the output speed drops as torque resistance increases.

Several attempts have been made to overcome this problem. One approach has been to use an enhanced drive system. Unfortunately, this often entails employing a multi-stage transmission and other complicated gearing arrangements, which cause the tool to have a longer length, to be heavier, and to cost more to manufacture.

Another proposed solution is simply to run supply air at higher pressures. Again, this approach is costly, because the higher the desired supply of air pressure, the more expensive it becomes in fuel and compressor size. And as just noted, not everyone has access to more powerful sources of pressurized air.

On the other hand, conventional dual-chamber air motors are known to provide significantly higher output power than single-chamber air motors, because they provide 170% of the blade area exposed to the volume of pressurized air than do single-chamber air motors. However, for that very reason they are also notorious “air hogs”, and they would likely quickly drain the typical small compressor tank available to homeowners and smaller contractors. Accordingly, until now, it has not been thought practical to use a dual-chamber air motor in a power tool.

Therefore, there is a need for a fluidically-driven power tool which solves the problem of drop-off in speed under load while still having a compact size at an appealing cost.

### SUMMARY OF THE INVENTION

It has been discovered that a dual-chamber air motor can, in fact, be used to drive a power tool by following the teachings of the present invention. By restricting the size of an air inlet to permit just enough volume of pressurized air into the motor chambers to drive the tool within an acceptable range of power, the “air hog” deficiency associated with conventional dual-chamber motors can be eliminated. In the vast majority of applications for which the power tool is used, this restricted air volume works just fine. And when the operator encounters the infrequent resistance in a workpiece that would otherwise stall the tool, the operator can actuate a two-step throttle-actuated dual ported mechanism of the present invention to admit boost air into the motor air chambers to augment the volume of pressurized air admitted into the motor. As a result, the stall is overcome and full power is delivered to the tool output member. Other benefits also result from the coactions of the dual-chamber motor and the air boost system of the present invention.

The dual-chamber motor of the present invention, while turning slower than a conventional single-chamber motor, yields about a 70% increase in power, as described above. This eliminates the need for a multiplication/speed reduction stage in the gearbox. Accordingly, in a tool that would otherwise utilize a single-stage gear reduction, by using the dual-chamber motor of the present invention, no gearing at all is required. In designs that would normally use two gear reduction stages, only one would be required if the dual-chamber motor of the present invention is used. The same effect would be achieved in a tool with a multi-stage drive system. Thus the dual-chamber motor of the present invention would literally eliminate a stage. Furthermore, by requiring only a 90 psi source of pressurized air, and by injecting much less volume of the air into the motor than would be thought possible with conventional dual-chamber air motors, a much “greener” power tool system can now be used.

Accordingly, it is an object of the present invention to provide a fluidically-driven power tool that uses a source of air pressurized at just 90 psi, regardless of the load encountered by the tool.

It is another object of the present invention to provide a fluidically-driven power tool that includes a multi-stage throttle-actuated dual ported mechanism that, when the first stage is actuated, admits pressurized fluid into a prime mover via a first delivery path in fluid communication with one of the ports; and, when the second stage is actuated, simultaneously admits pressurized fluid into the prime mover via a second delivery path in fluid communication with the other port to augment the volume of pressurized air admitted to the prime mover.

It is still another object of the present invention for the mechanism to include a primary throttle and a secondary throttle, in which an operator can move a trigger stem axially to actuate the primary throttle, and, if desired, can move the trigger stem further axially to also actuate the secondary throttle to boost the volume of pressurized fluid admitted to the prime mover, which, in one embodiment of the present invention, includes a fluidically-driven rotary motor.

It is a still further object of the present invention to alert an operator when the throttle system actuator is about to open the secondary throttle, thereby conserving pressurized fluid.

It is another object of the present invention to alert the operator by using a dual-rate compression spring assembly which resists further axial advancement of the trigger by a sudden increase in resistance perceived by the operator when the trigger stem approaches the fluid boost point.

It is yet another object of the present invention to provide a method for driving a fastener into a workpiece using a power tool driven by a fluidically-driven motor which enables the operator to sense a change in resistance in the workpiece to driving the fastener, then to selectively boost the volume of pressurized fluid in the motor, thereby driving the fastener without using a clutch mechanism operatively associated with the motor and the fastener.

It is another object of the present invention to use air as the pressurized fluid and to admit air from the secondary throttle through a rear end plate of an air motor.

It is still another object of the present invention to provide a dual-chamber air motor for a power tool, which generates an increased level of output torque, at the desired output speed for a power tool, to yield a more compact power tool than one powered by single-chamber air motor.

It is yet another object of the present invention to admit pressurized air generally radially through the dual-chamber motor cylinder sleeve to rotate a rotor axially disposed in the cylinder sleeve, and, upon subsequent actuation by an operator, to simultaneously admit pressurized air axially into the rear end plate attached to the rear end of the cylinder sleeve, thereby boosting the volume of pressurized air into the motor and eliminating a multiplication/speed reduction stage in the drive system of a power tool.

It is a further object of the present invention to provide the cylinder sleeve with a plurality of axial air passages extending from a front end plate attached to the front end of the cylinder to the rear end plate, the axial air passages being in fluid communication with the generally radial air inlets in the cylinder sleeve.

It is still another object of the present invention to further include an array of air passages in the rear end plate which convey pressurized air from the cylinder sleeve axial air passages to slots formed in the inside face of the rear end plate of the air motor, which slots in turn direct pressurized air to the bases of the air vanes to bias them radially outwardly from the rotor, and, in conjunction with the volume of air entering via the generally radial air inlets in the cylinder sleeve, to drive the vanes and rotate the motor.

It is yet another object of the present invention to equip the air-driven power tool with an air exhaust system that selectively diverts a portion of the air motor exhaust axially forwardly, and directs the same at a bit drivingly connected to the motor.

Other features and advantages of the present invention will become apparent from the following description when viewed in accordance with the accompanying drawings and appended claims.

### BRIEF DESCRIPTION OF THE DRAWINGS

FIG. 1 is a view of one embodiment of a fluidically-driven power tool of the present invention.

FIG. 2 is a side elevational sectional schematic view of the power tool of FIG. 1, showing one embodiment of a throttle system of the present invention, with the throttle system in the “off” mode.

FIG. 3 is the power tool of FIG. 2, showing the throttle system in the “feathering” mode.

FIG. 4 is the power tool of FIG. 3, showing the throttle system in the “full power” mode.

FIG. 5 is the power tool of FIG. 3, showing the throttle system in the “air boost” mode.

FIG. 6 is an exploded perspective view of a primary throttle of the throttle system of the present invention.

FIGS. 7A and 7B are perspective detail views of a regulator according to the present invention, taken from the front and rear, respectively.

FIG. 7C is a side elevational view of the regulator of FIG. 7A.

FIG. 7D is a sectional view taken along line 7D-7D of FIG. 7C.

FIG. 7E is a sectional view taken along line 7E-7E of FIG. 7C.

FIG. 7F is a front elevational view of the regulator of FIG. 7A.

FIGS. 8A and 8B are perspective detail view of a forward-reverse valve according to the present invention, taken from the front and rear, respectively

FIG. 8C is a top plan view of the forward-reverse valve of FIG. 8A.

FIG. 8D is a front elevational view of the forward-reverse valve of FIG. 8A.

FIG. 8E is a side elevational view of the forward-reverse valve of FIG. 8A.

FIG. 8F is a sectional view taken along line 8F-8F of FIG. 8D.

FIG. 8G is a sectional view taken along line 8G-8G of FIG. 8E.

FIG. 8H is a sectional view taken along line 8H-8H of FIG. 8E.

FIG. 9A is a top plan detail view of a throttle sleeve according to the present invention.

FIG. 9B is a bottom plan view of the throttle sleeve of FIG. 9A.

FIG. 9C is a side elevational view of the throttle sleeve of FIG. 9A.

FIG. 9D is a front elevational view of the throttle sleeve of FIG. 9A.

FIG. 9E is an elevational sectional view taken along line 9E-9E of FIG. 9A.

FIG. 10 is a partially cut-away schematic sectional view, taken along line 10-10 of FIG. 2, showing the forward-reverse valve of the present invention in the “forward” position, and illustrating the throttle air flow passages, as well as an air motor of the present invention.

FIG. 11 is a view similar to FIG. 10, but showing the forward-reverse valve in the “reverse” position.

FIGS. 12A and 12B are perspective detail views, taken from the front and rear, respectively, of a regulator knob of the present invention.

FIGS. 13A and 13B are perspective detail views, taken from the front and rear, respectively, of a forward-reverse lever of the present invention.

FIG. 13C is a front elevational view of the forward-reverse lever of FIG. 13A.

FIG. 13D is a rear elevational view of the forward-reverse lever of FIG. 13A.

FIG. 13E is a side elevational view of the forward-reverse lever of FIG. 13A.

FIG. 13F is a top view of the forward-reverse lever of FIG. 13A.

FIG. 14 is a detail view of a trigger stem of the present invention.

FIG. 15 is an exploded perspective view of the tip valve assembly of the present invention.

FIG. 16 is a view, similar to FIG. 3, of another embodiment of a throttle system of the present invention

FIG. 17 is a speed/torque graph illustrating the effect of a power boost system upon the speed/torque characteristics of an air-driven power tool.

FIG. 18 is a schematic view, partially cut away, of a single-chamber rotary air motor.

FIG. 19 is a schematic view, partially cut away, of a dual-chamber rotary air motor of the present invention.

FIG. 20 is a perspective view of a dual-chamber rotary air motor of the present invention.

FIG. 21 is an exploded perspective view of a dual-chamber rotary air motor of the present invention.

FIGS. 22A and 22B are perspective detail views, taken from the front and rear, respectively, of a cylinder sleeve of a dual-chamber rotary air motor of the present invention.

FIG. 22C is a rear elevational view of the cylinder sleeve of FIG. 22A.

FIGS. 22D and 22E are elevational views, taken from opposite sides, of the cylinder sleeve of FIG. 22A

FIGS. 22F and 22G are top and bottom plan views, respectively, of the cylinder sleeve of

FIG. 22A.

FIGS. 23A and 23B are front and rear elevational detail views, respectively, of a rear end plate of a dual-chamber rotary air motor of the present invention.

FIG. 23C is a side elevational detail view of the rear end plate of FIG. 23A.

FIG. 23D is a top plan view of the rear end plate of FIG. 23A.

FIG. 23E is an elevational sectional view taken along line 23E-23E of FIG. 23A.

FIG. 23F is a sectional view taken along line 23F-23F of FIG. 23C.

FIGS. 24A and 24B are enlarged perspective detail views taken from the front and rear, respectively, of the rear end plate of FIG. 23A.

FIG. 25 is a view of another embodiment of a fluidically-driven power tool of the present invention.

FIG. 26 is a schematic sectional view, partially cut away, taken along line 26-26 of FIG. 25 and illustrating an auxiliary exhaust system of the present invention.

FIG. 27 is an exploded perspective view of a compact drive system of a fluidically driven power tool of the present invention.

FIG. 28A is an exploded perspective detail view of a steel ring gear and Titanium gear head housing of the compact drive system of FIG. 27.

FIG. 28B is a side elevational sectional view of the assembly of the ring gear and gear head housing taken along line 28B-28B of FIG. 28A.

### DETAILED DESCRIPTION OF THE PREFERRED EMBODIMENTS

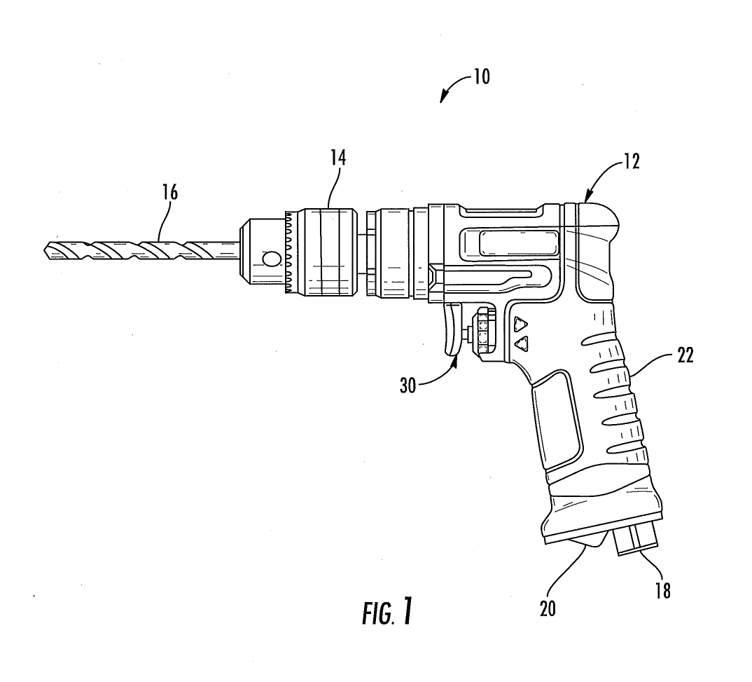

FIG. 1 shows one embodiment of a fluidically-driven power tool 10 of the present invention. Although the embodiment shown uses an air-powered motor as the prime mover to drive a drill bit, it will be appreciated that the present invention is also applicable to tools using other pressurized fluids to drive several types of prime movers to drive other types of output members. For example, it is contemplated that the concepts of the throttle system of the present invention could also be applied to such tools as hammers, having impact mechanisms driven by such prime movers as reciprocating fluid-driven piston systems using various numbers and configurations of fluid chambers.

The embodiment of the power tool 10 described in detail herein includes a housing 12, a chuck 14 driven by the power tool, to which a tool element such as a drill bit 16 is connected. The power tool 10 is connected to a source of pressurized air (not shown) by a connection 18, and exhausts air through a handle exhaust outlet 20, the connection and exhaust outlet being disposed at the base of a handle 22. A multi-stage throttle-actuated dual-ported mechanism 30 (hereinafter referred to as a “throttle system”), actuatable by an operator, controls pressurized air from the connection 18 to drive the drill bit 16 at one of a plurality of different speeds, either in forward or reverse. The throttle system 30 is also operative, upon operator actuation, to boost the output speed and torque of the drill bit 16 when a drop-off in speed is sensed by the operator, as will later be described.

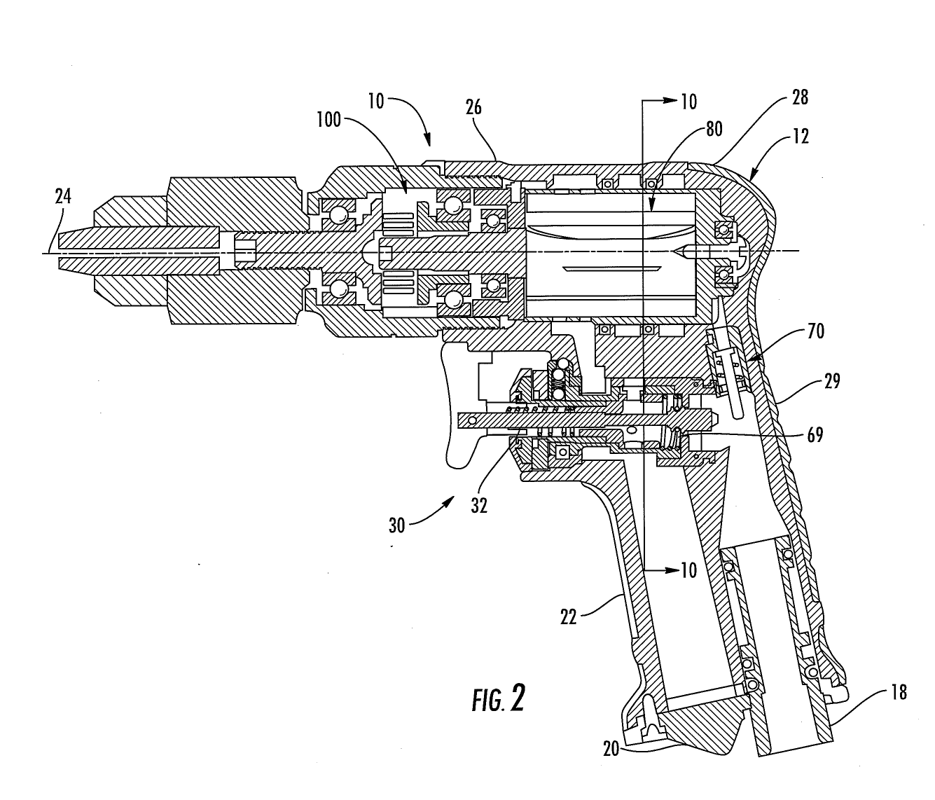

Referring to FIG. 2, the housing 12 is preferably molded from a suitable plastic material, such as a glass-filled nylon, although, if desired, other materials, such as aluminum, may also be used. It is recommended, however, if aluminum is used, that means be provided for insulating the handgrip area of the handle, inasmuch as a metal handle can become cold due to the flow of exhaust air through it. The housing 12 includes a drive system housing portion 26, a motor housing portion 28 and a handle housing portion 29. The throttle system 30, disposed in handle housing portion 29, controls the flow of pressurized air from the connection 18 to an air motor 80 disposed in the motor housing portion 28. The air motor 80 is connected along a longitudinal axis 24 to a compact drive system 100 to rotate the drill bit 16 at the desired output speed and torque, which in this embodiment of the power tool 10 of the present invention, is about 1800 rpm at about 17 to 18 inch-pounds of torque using a supply of air pressurized at 90° psi. However, as described above, the use of the dual-chamber motor 80 and throttle system 30 of the present invention makes it possible to eliminate entirely the single-stage planetary drive system 100, if so desired. As will later be described, this is achieved by the use of a dual-chamber rotary vane air motor of the present invention, in concert with an air boost system of the present invention. This contrasts with conventional air-driven power tools, which use single-chamber rotary vane air motors to deliver only 1200 rpm to the drill bit. As previously noted, up to now, in order to provide conventional air-powered power tools with higher output speeds at sufficient torque levels, it has been necessary to use a multi-stage or other enhanced transmission, which adds cost, complexity, weight, and especially length to the power tool. In the alternative, it has been necessary to supply conventional air tools with sources of air at higher pressure. This again results in greater cost.

Thus, the power tool 10 of the present invention can be made more compact and less complex than conventional air-driven power tools, while delivering the right speed and torque to the drill bit, especially when encountering a workpiece resistance at the bit that would normally stall conventional air tools.

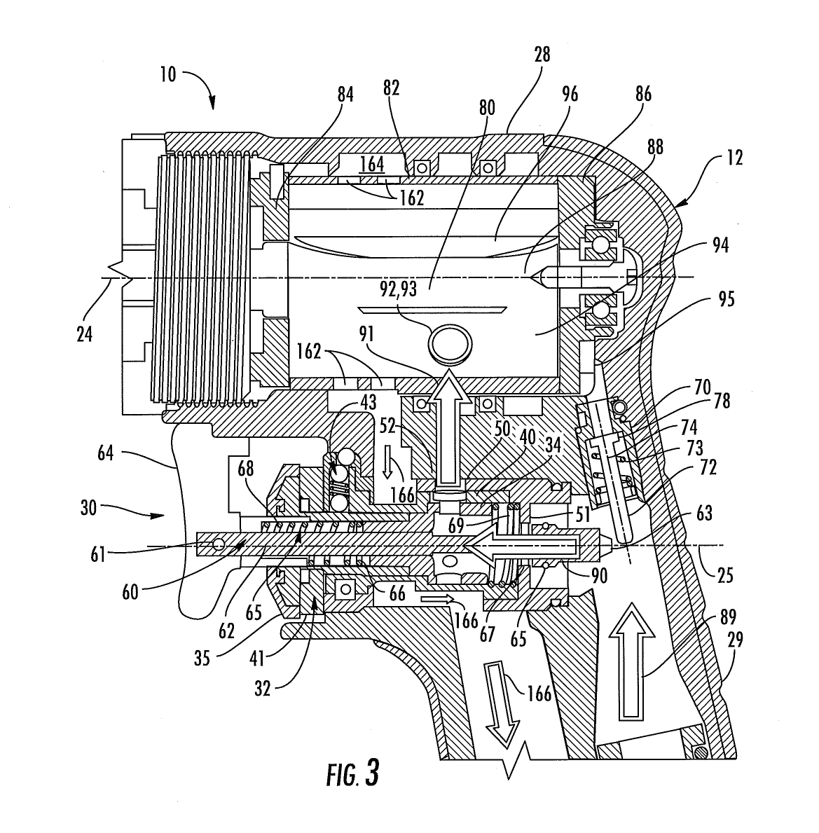

The air boost system of the present invention will be described now with reference to FIGS. 2-5. Referring first to FIG. 3, the throttle system 30 of the present invention includes a primary air throttle 32 and a secondary air throttle 70. The primary air throttle 32 includes a regulator 34 coaxially and rotatably disposed within a forward-reverse valve 40, which is in turn coaxially and rotatably disposed in a non-rotatable throttle sleeve 50, along a longitudinal axis 25. The regulator 34 is configured to rotate with, but also to rotate selectively independently of, the forward-reverse valve 40. A throttle actuator 60 includes a primary throttle stem (or trigger stem) 62, axially moveable and coaxially disposed within the primary throttle 32. The trigger stem 62 has a trigger end 61; a trigger 64 engageable by an operator is connected to the trigger end 61. The trigger stem 62 further includes a first valve member 65 normally biased into sealing engagement with a first valve seat 67 formed in the throttle sleeve 50, the first valve member and first valve seat coacting to form a first valve.

The biasing is accomplished by a large-diameter trigger compression spring 66 to provide a relatively heavy biasing force, and a small-diameter trigger compression spring 68 to provide a relatively light biasing force, coaxially disposed about the trigger stem 62, to form a dual-rate spring assembly 65 that provides a tactile alert to the operator, as will be described more fully below. Auxiliary biasing is provided by a compression spring 69, which is trapped between the regulator 34 and an interior wall 51 of the throttle sleeve 50. The purpose of the auxiliary biasing is to keep the regulator 34 pressed into axial engagement with the rest of the primary throttle 32.

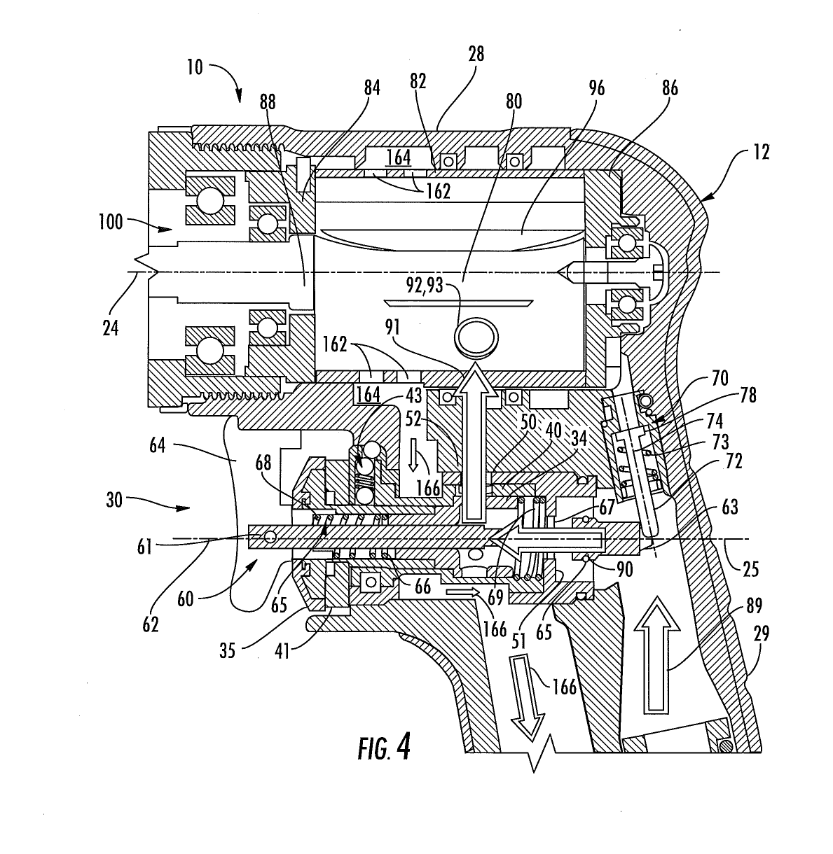

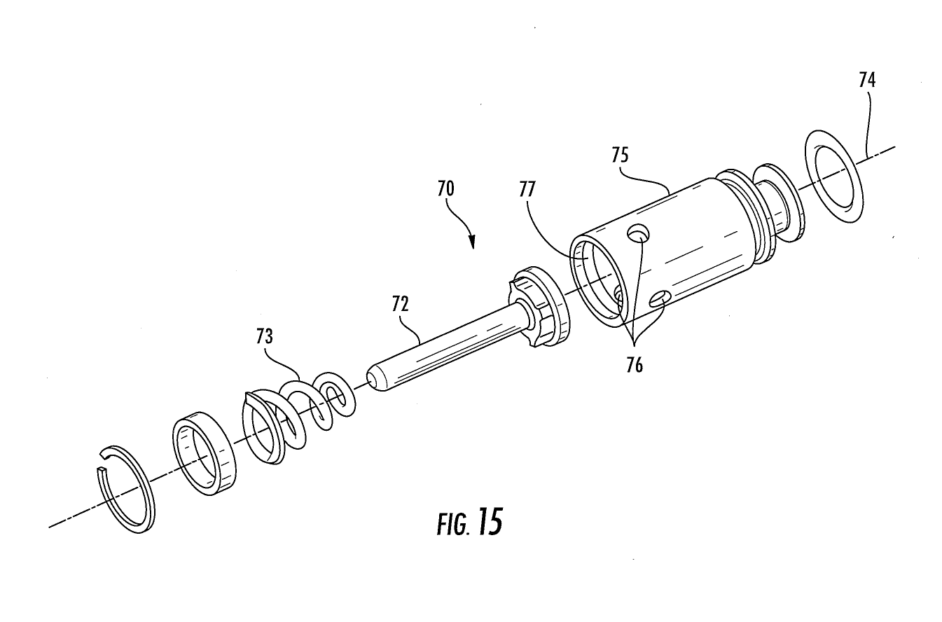

As shown in FIGS. 4, 5, 14 and 15, the tip valve-engaging end 63 of the trigger stem 62 is engageable with a tip valve 72 of the secondary air throttle 70, to displace the tip valve from sealing engagement with its valve seat, thus opening the secondary air throttle. The tip valve 72 is normally biased by a spring 73 into sealing engagement with the valve seat 78 and to lie along a longitudinal axis 74. As will be described later, other throttles beside a tip valve may be used as the secondary throttle 70.

Referring now to FIGS. 2, 3, 10 and 11, as previously noted, the throttle system 30 of the present invention admits a predetermined restricted volume of pressurized air into the dual-chamber rotary motor 80 of the present invention. The motor 80 includes an air motor cylinder sleeve 82 having a generally oblong cross-section. The motor 80 further includes a front end plate 84 and a rear end plate 86. A rotor 88 mounting a plurality of radially-moveable air vanes 94 is coaxially disposed in the cylinder sleeve 82 intermediate the plates 84, 86, and, together with the cylinder sleeve, define two radially-opposed air chambers 96. Two air passages 92, 93 in motor housing portion 28 convey the predetermined restricted volume of pressurized air from primary air throttle 32 to generally radial air inlets 138, 140 formed through cylinder sleeve 82, while a generally radial air passage 95, created by the combination of the motor housing portion with a partial radial air passage formed in rear end plate 86, conveys pressurized air from secondary air throttle 70 to an axial air inlet 99 also formed in the rear end plate, details of which will be described later.

Although details of the throttle system 30 of the present invention will be discussed later, its operation will now be described with reference to FIGS. 2-5. The trigger stem 62 is axially moveable in the throttle sleeve 50 from an “off” position shown in FIG. 2, in which both the primary and secondary air throttle 32, 70 are closed, to a “feathering” position, shown in FIG. 3. “Feathering” causes the drill bit 16 to toggle at a slow speed to help “find” a spot for drilling a material. To accomplish this, the operator actuates the trigger 64 to move the trigger stem 62 an axial distance of about 0.100 inch inwardly into the throttle sleeve 50, against the bias of small-diameter compression spring 68.

This axial movement partially disengages the first valve member 65 from the first valve seat 67. As a result, as shown by arrows 89 and 90, air from the 90 psi source of pressurized air is admitted into the primary throttle 32 at a relatively low volume. That air is then admitted into the air motor 80, as shown by arrow 91.

When it is desired to run the air motor 80 at full power, the operator actuates the trigger 64 to move the trigger stem 62 axially about another 0.100 inch, as shown in FIG. 4. This causes the first valve member 65 to fully separate from the first valve seat 67. As previously noted, the size of the air inlets or ports leading from the valve to the motor 80 may be restricted so that air enters the motor at about 30-40 psi, but at a volume which is still sufficient to drive the drill bit at the desired speed and torque.

However, if the operator senses a significant drop in speed of the drill bit 16 due to resistance of the workpiece, the operator can boost the volume of pressurized air delivered to the air motor 80 of the present invention by actuating the trigger 64 to move the trigger stem 62 axially inwardly yet another 0.100 inch, as shown in FIG. 5. This in turn moves a stem of the tip valve 72 off-center, thereby tipping a tip valve head away from the mating valve seat 78, and opening the secondary air throttle 70, as shown by arrows 102. Now pressurized air can be directed via a tip valve bushing or port 75 towards the motor rear end plate 86, simultaneously with the pressurized air admitted by the primary air throttle 32. As shown in FIGS. 5 and 15, tip valve bushing 75 defines radial air inlets 76 to ensure that a tip valve bushing air chamber 77 is continuously pressurized. Referring again to FIG. 5, air is ultimately admitted into the air motor 80 via the rear end plate axial air inlet 99, as will be described in more detail below. The air boost is sufficient to augment the volume of air admitted to the motor 80 to resume driving the drill bit 16 at the desired speed and torque. The availability of the air boost of the present invention, in conjunction with using the dual-chamber air motor 80 of the present invention, thus eliminates a stage of a multi-stage planetary drive systems or other extra gearing arrangements, which would otherwise be necessary in power tools with conventional single-chamber rotary air motors to provide the desired output speed and torque to a drill bit, especially under significant load.

Thus, the throttle system 30 of the present invention delivers pressurized air to the motor via first and second delivery paths in fluid communication with each of two ports in the two-stage throttle-actuated dual-ported mechanism of the present invention.

To conserve pressurized air, it is desirable that the air boost of the present invention be actuated only when necessary to overcome significant torque resistance, as described above. Accordingly, the dual-rate spring assembly 65 is configured to alert the operator that the trigger stem 62 is approaching the axial position in which the air boost is about to be actuated, by providing a sudden increase in resistance to further axial movement of the trigger 64, which increase can be readily sensed by the operator. This is accomplished first by locating the small-diameter spring 68 so that a relatively light resistance is sensed by the operator from the “off” position of the trigger all the way through the “full power” position. The large-diameter spring 66 is axially shorter than the small-diameter spring 68, and is not engaged until the trigger stem 62 is about to actuate the secondary air throttle 70. At this axial point, the resistance forces of the two springs 66, 68 become additive and produce a sharp increase in reaction force. In this embodiment of the air boost system of the present invention, a total spring resistance of about 8 pounds has been found to be effective to so alert the operator.

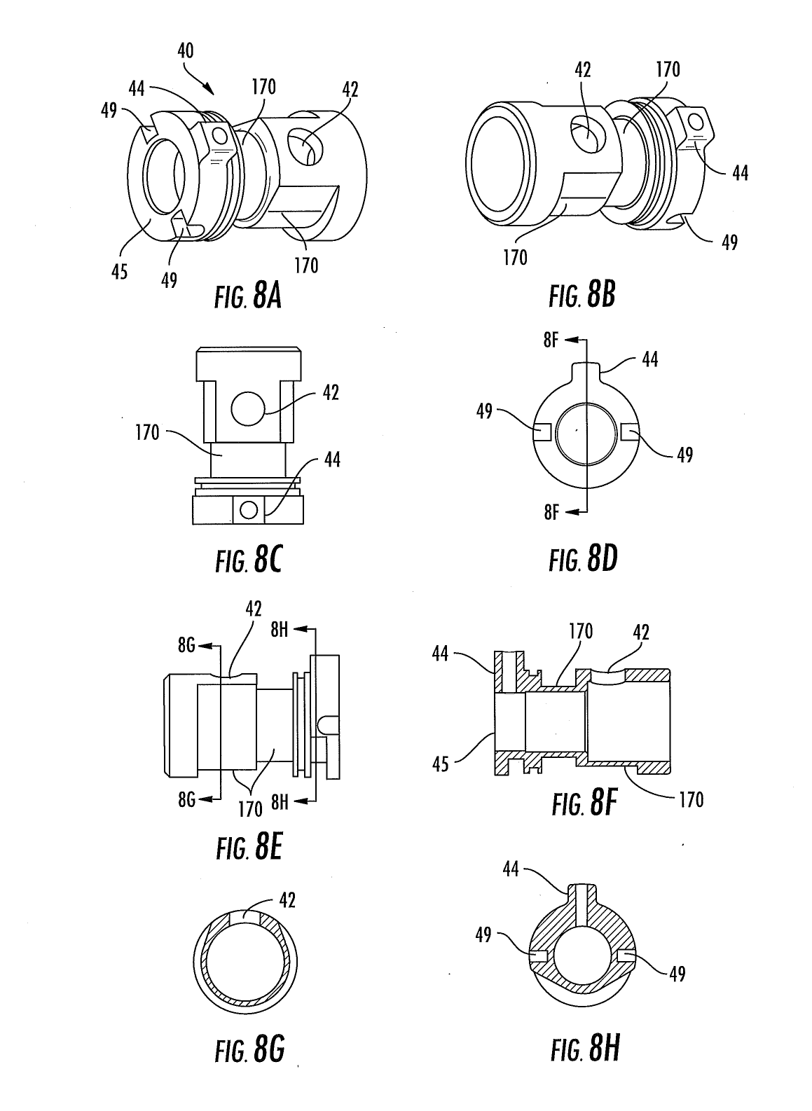

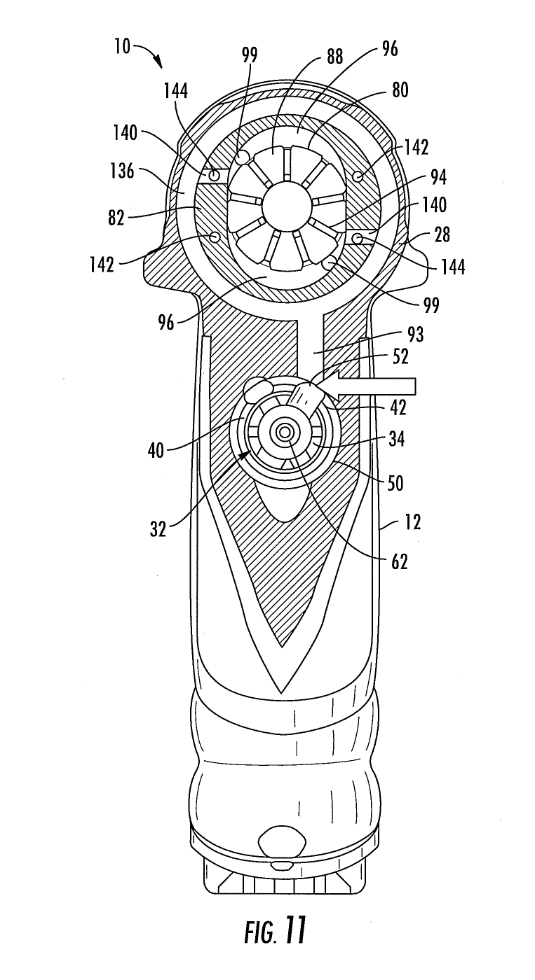

The operation of the forward-reverse valve 40 and the regulator 34 of the primary throttle 32 of the present invention will now be described in more detail with reference to FIGS. 2, 3, 6, 7A-7E, 8A-8H, 9A-9E, 10 and 11, 12A and 12B, and 13A-13F.

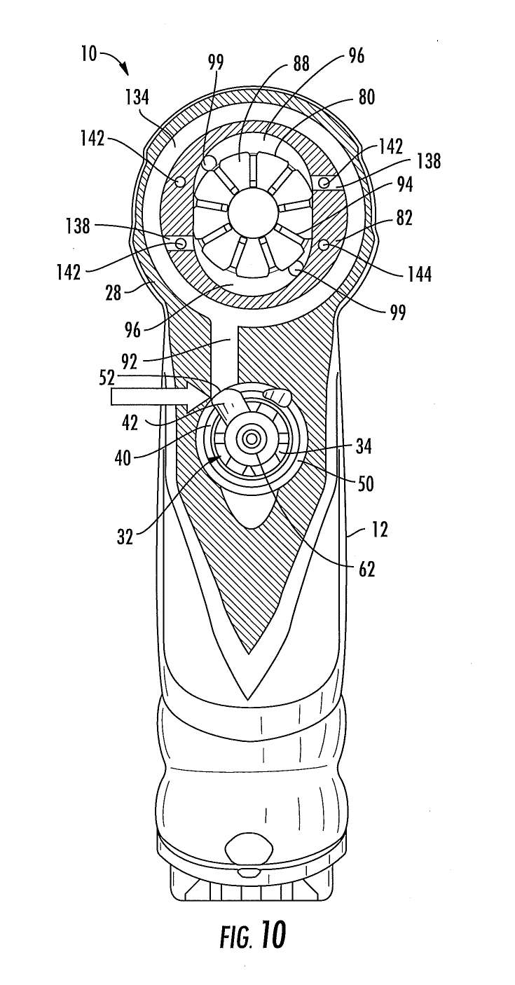

As shown in FIGS. 6, 9A-9E, 10 and 11, the throttle sleeve 50 defines two circumferentially-spaced radial air passages 52 in fluid communication with the source of pressurized air when the primary air throttle 32 is opened. In this embodiment of the primary air throttle 32 of the present invention, the radial air passages 52 are circumferentially spaced 60 degrees apart. As shown in FIG. 10, one of the two air passages 52 is so located in the throttle sleeve 50 as to drive the air motor 80 in the forward direction. As shown in FIG. 11, the other air passage 52 is so located as to drive the air motor 80 in the reverse direction. (It should be noted that FIGS. 2-5 illustrate the forward-reverse valve 40 in the reverse position.)

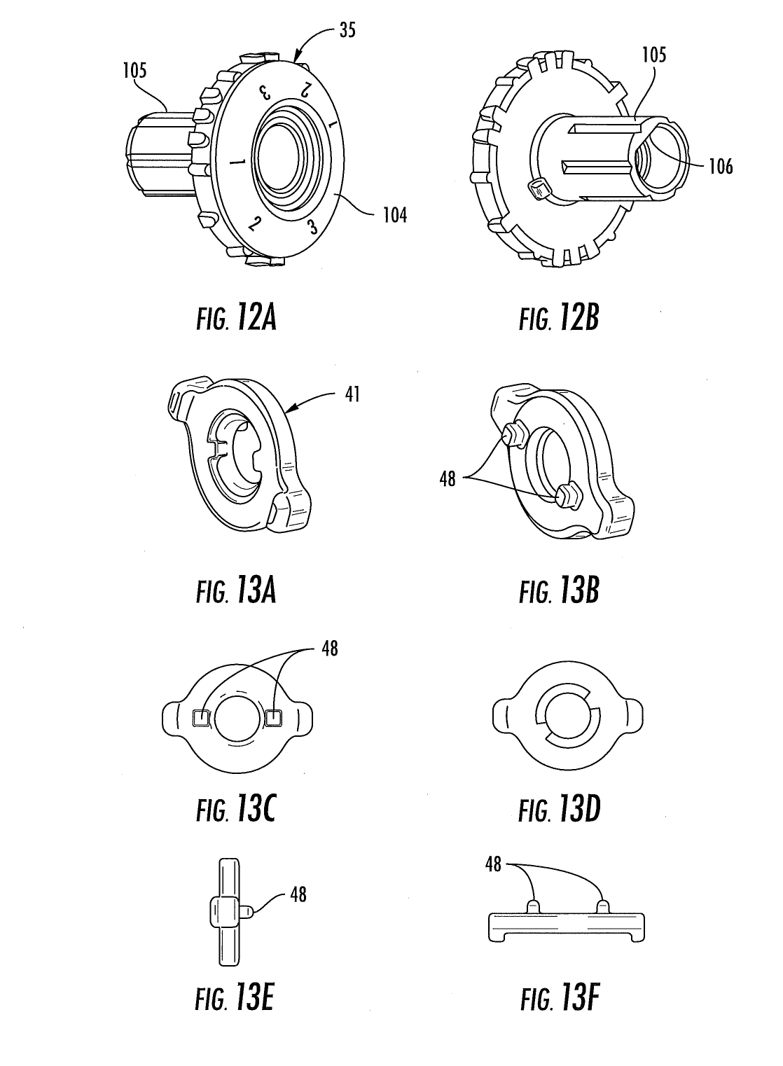

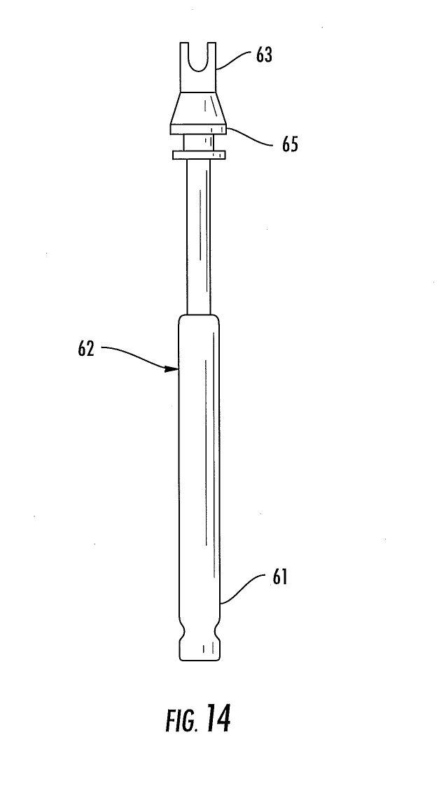

Now referring to FIGS. 3-6, 8A-8H, 10 and 11, the forward-reverse valve 40 also defines its own, restricted-diameter radial air passage or port 42. The forward-reverse lever 41, shown in more detail in FIGS. 13A-13F, defines two axially extending drive lugs 48, which engage mating axial recesses 49 formed in an inner face of the forward-reverse valve 40. When the forward-reverse lever 41 is rotated 60 degrees clockwise or counter-clockwise, it selectively aligns the forward-reverse valve radial air passage 42 with one of the two circumferentially-spaced radial air passages 52 in the throttle sleeve 50, which may be sized to generally correspond with the size of the port 42. Accordingly, the operator can run the air motor 80 in either the forward or reverse direction.

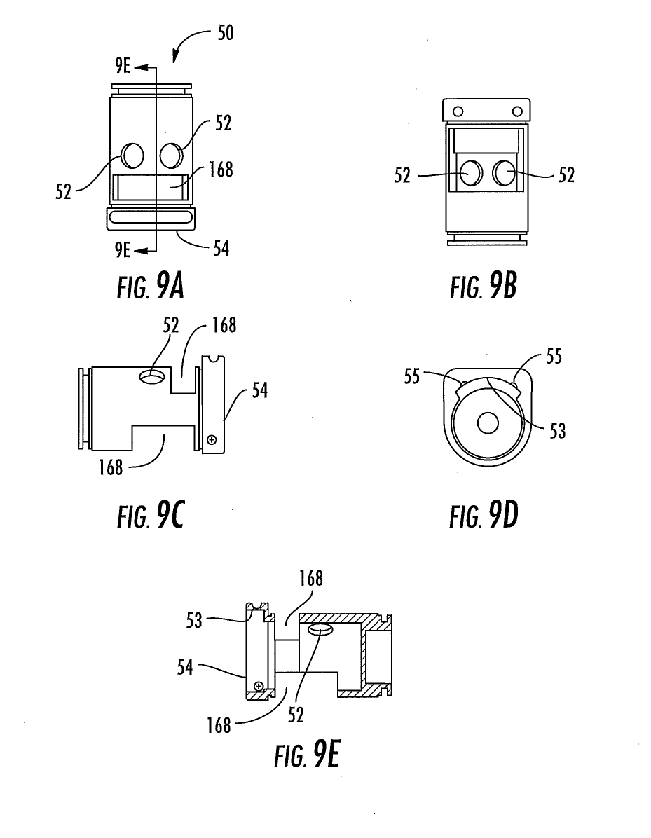

With particular reference to FIGS. 3-6 and 8A-8H, the primary air throttle 32 also includes a detent system 43 for releasably holding the forward-reverse valve 40 in one of its two circumferential positions. A chimney 44 formed on the axially-inner end 45 of the forward-reverse valve 40 includes two spaced spring-biased ball detents 46, one of which bears against the regulator knob 35, and the other of which bears against an inner curved portion 53 of a front end 54 of the throttle sleeve 50, as shown in FIG. 9D. The inner curved portion 53 defines two circumferentially-spaced small depressions 55 sized to coact with the upper ball 46 to hold the forward-reverse valve 40 in position until the operator once again rotates the forward-reverse lever 41 to change direction. The depressions 55 are also circumferentially spaced 60 degrees to correspond with the amount of circumferential travel of the forward-reverse valve 40.

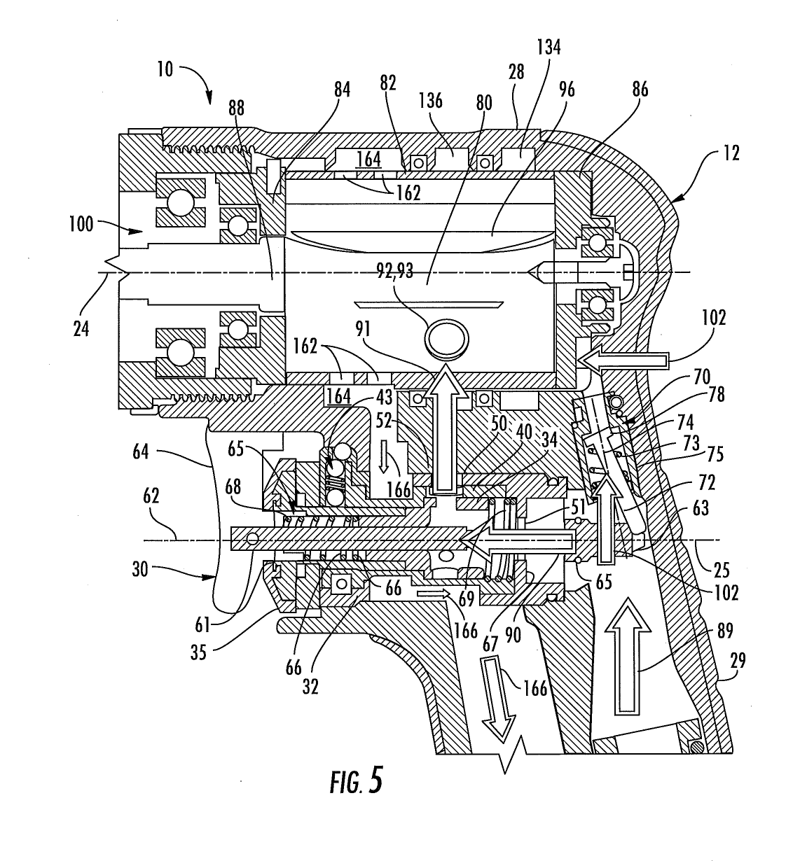

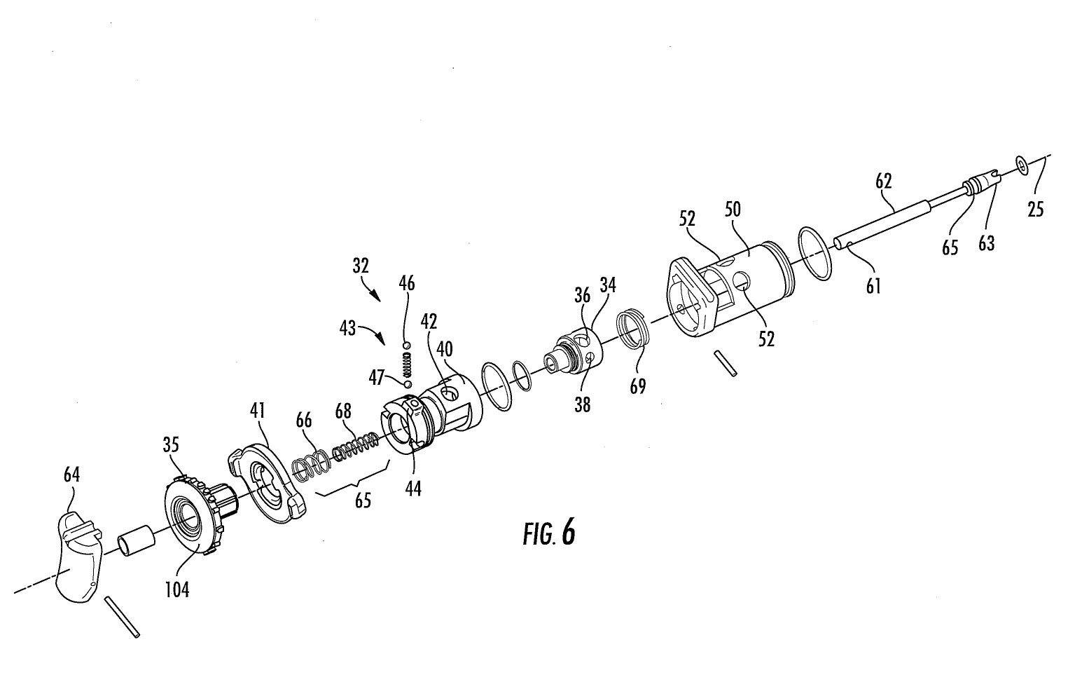

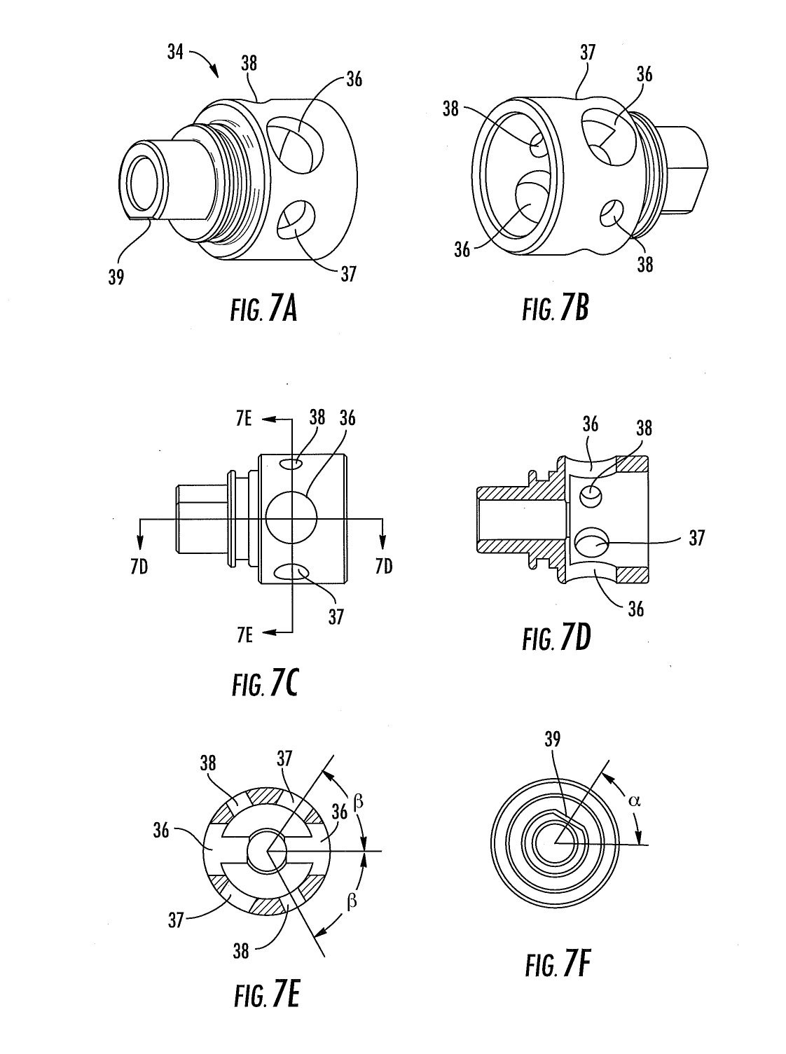

The operation of the regulator 34 of the present invention is illustrated in FIGS. 3-6, 7A-7F, 10 and 11, and 12A and 12B. With particular reference to FIGS. 7A-7F, the regulator 34 defines two identical sets of three different, circumferentially-spaced radial air passages 36, 37, 38, sized to admit air at three different volumes into the motor air chamber 96. In this embodiment of the regulator 34 of the present invention, the radial air passages 36, 37, 38 are circumferentially-spaced an angle β of 60 degrees. This arrangement will yield three different motor speeds, with the largest-diameter air passage 36 yielding the full-power speed. The two sets of air passages 36, 37, 38 are provided so that the speed can be controlled at either of the two circumferential positions of the forward-reverse valve 40, as shown in FIGS. 10 and 11. Regulator knob 35, shown in FIGS. 4-6, 12 A and 12B, includes an outer surface 104 numbered to indicate the desired speed, and a shaft portion 105, extending axially inwardly into the primary air throttle 32. The regulator knob 35 traps the forward-reverse lever 41 against the forward-reverse valve 40 and an inner axial end 54 of the throttle sleeve 50. The regulator knob shaft portion 105 is rotatably disposed within the forward-reverse valve 40 and defines an internal flat portion 106 disposed at an angle α drivingly engaged with a corresponding flat portion 39 formed on the regulator 34, as shown, for example, in FIGS. 7A and 7F. As a result, the regulator 34 can be rotated independently of the rotation of the forward-reverse valve 40, as illustrated in FIGS. 10 and 11.

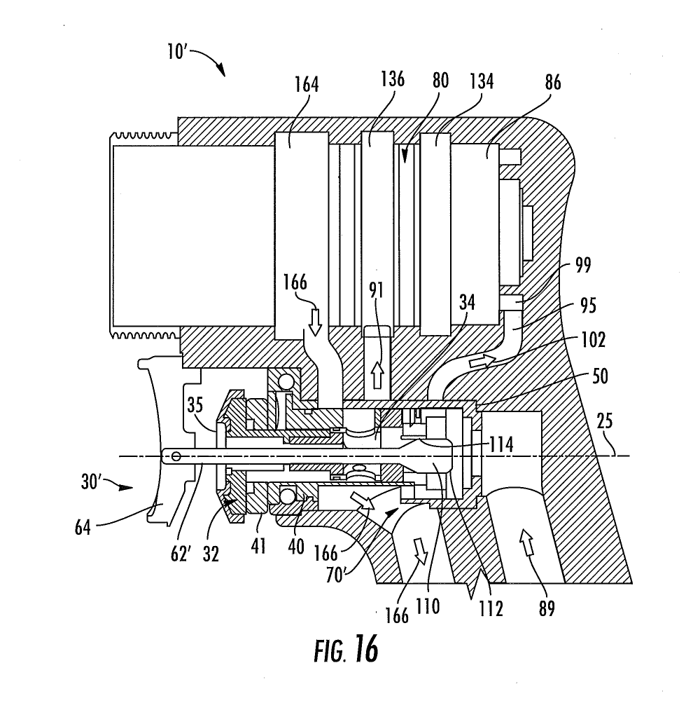

Another embodiment of the power tool 10′ of the present invention showing another embodiment of the air throttle system 30′ is shown in FIG. 16, and is similar to the one described above. However, in this embodiment, the secondary air throttle 70′ is axially aligned with the primary air throttle 32, so that axial movement of the throttle stem 62′ to the air boost position opens a second valve 110. The second valve 110 includes a valve head portion 112 formed on the trigger stem 62′, which is normally sealingly engaged with a second valve seat 114. When the second valve 110 is opened, air at boost pressure is directed to the axial air inlet 99 in the air motor rear end plate 86, just as was described above regarding the operation of the first embodiment of the secondary air throttle 70. Both embodiments of the throttle system 30, 30′ of the present invention yield a significant enhancement of the power tool's performance when it is subjected to strong workpiece resistance, as illustrated in the speed/torque curve 116 shown in FIG. 17, where the area under the curve under boost conditions reflects the additional power provided to an output member. It can be appreciated that the secondary air throttle 70, 70′ may be located at any appropriate attitude relative to the primary throttle 32, including, for example, lying along an axis which is parallel to, and not coincident with, the primary throttle axis 25.

The embodiments of the throttle system 30, 30′ of the present invention have been described as controlling pressurized air to a dual-chamber air motor 80 of the present invention. However, the throttle system 30, 30′, if desired, may also be adapted for use with a single-chamber rotary vane air motor 118 using the principles set forth above. Such a single-chamber air motor 118 is illustrated in FIG. 18.

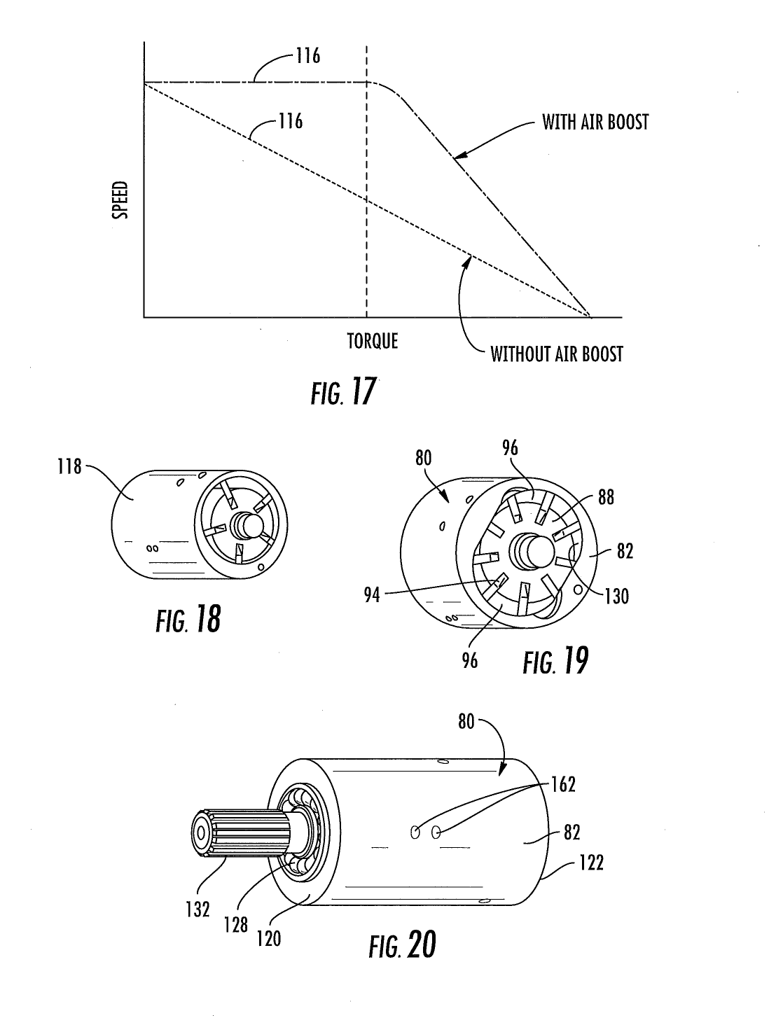

As previously noted, however, significant benefits in power tool performance, as well as a more compact tool design, can be attained with the dual-chamber air motor 80 of the present invention, particularly when used in concert with the air boost system of the present invention. The dual-chamber air motor 80 of the present invention is illustrated in FIGS. 19 and 20, and is shown in detail in FIGS. 21, 22A-22G, 23A-23F, and 24A and 24 B.

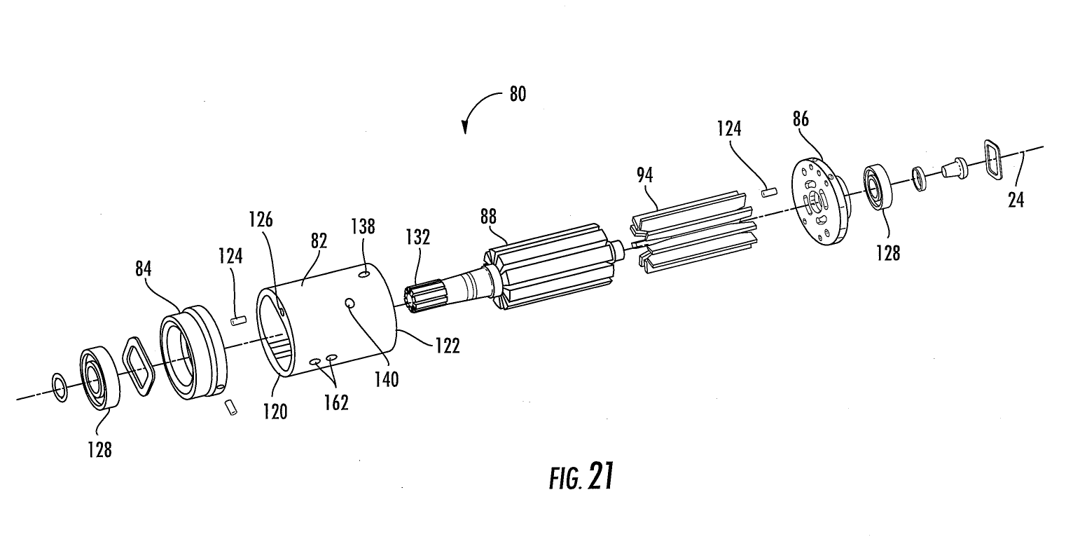

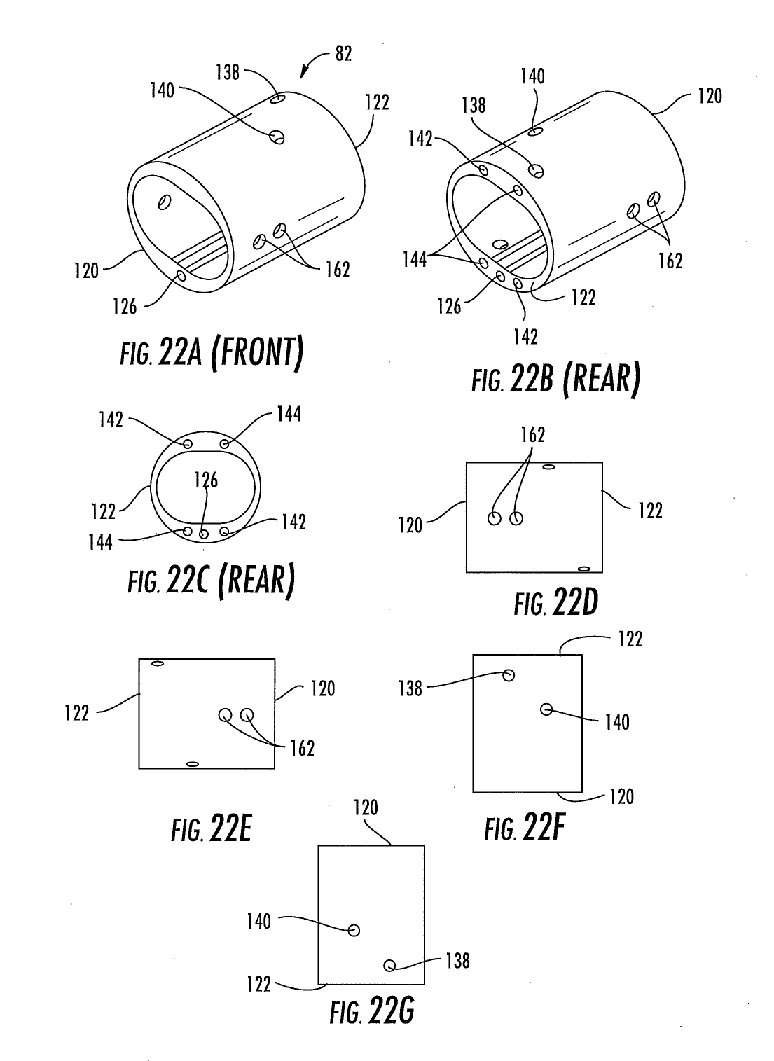

Referring first to FIGS. 19, 20 and 21, the air motor 80 of the present invention includes cylinder sleeve 82 defining a longitudinal axis 24, and having a front end 120 and a rear end 122. Pins 124 locate the front and rear end plates 84, 86 on the front and rear ends 120, 122, respectively, of the cylinder sleeve 82 via pin holes 126 in the cylinder sleeve 82 and front and rear end plates 84, 86. Bearings 128 are mounted in the front and rear end plates 84, 86, and rotatably support the rotor 88, which is disposed in the cylinder sleeve 82 along the axis 24. The plurality of air vanes 94 are radially moveably connected to the rotor 88; during operation of the air motor 80 of the present invention, they sweep against an interior surface 130 of the cylinder sleeve 82, as illustrated in FIG. 19. In this embodiment of the air motor 80 of the present invention, nine vanes 94 are used for optimum results, although it can be appreciated that a different quantity may be used if desired. The rotor 88 includes a pinion portion 132, which drivingly engages the compact drive system 100 of the present invention to rotate the drill bit 16 or other tool member. In any event, the rotor and vane assembly coact with the cylinder sleeve 82 to create the rotating dual eccentric air chambers 96, as shown in FIG. 19. Pressurized air directed into the air chambers 96 pushes against the vanes 94 and rotates the rotor 88, either forward or in reverse. FIGS. 22A-22G, 23A-23F, and 24A and 24B, viewed in conjunction with FIGS. 5, 10 and 11, will show the operation of the various air passages and air inlets in the housing 12 and the air motor 80, respectively, and their respective air flows, to drive the air motor of the present invention.

As shown in FIGS. 5, 10, 11, 16 and 22A-22B, forward and reverse air chambers 134,136, respectively, are formed in the motor housing portion 28 concentrically about the cylinder sleeve 82. Depending upon the circumferential position of the forward-reverse valve 40, a predetermined restricted volume of pressurized air from the primary air throttle 32, 32′ is selectively admitted into either chamber 134 or chamber 136. This air is communicated directly to the motor air chambers 96 via two sets of forward and reverse, generally radial air inlets 138, 140, respectively, formed in the cylinder sleeve 82, there being one set for each motor chamber 96. The air inlets 138, 140 may also be sized to restrict the volume of pressurized air admitted to the motor 80, either in place of, or in addition to, the restriction effected via the primary throttle 32, 32′. Also, the air inlets 138, 140 are so located and configured with respect to the rotor 88 and vanes 94 as to drive the rotor in forward or reverse, as desired. However, in the air motor 80 of the present invention, the generally radial air inlets 138, 140 are also in fluid communication with two sets of axially-extending air passages 142, 144 formed in the cylinder sleeve 82, as illustrated in FIGS. 22B and 22C, and especially in FIGS. 10 and 11. Thus, pressurized air is also conducted the length of the cylinder sleeve 82 to the rear end plate 86.

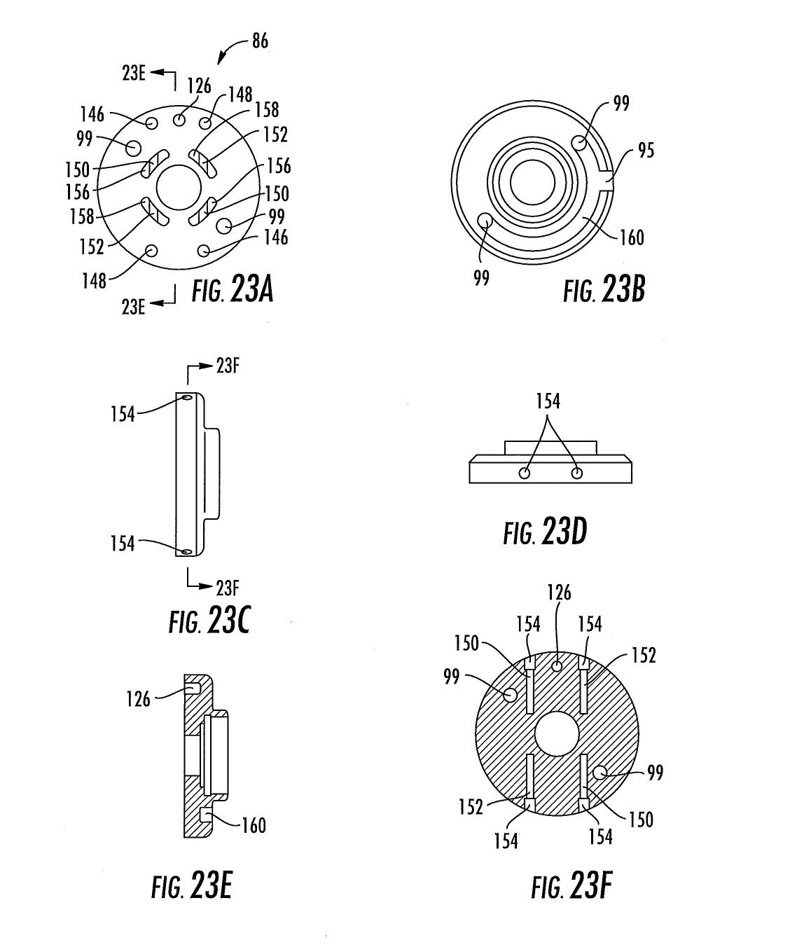

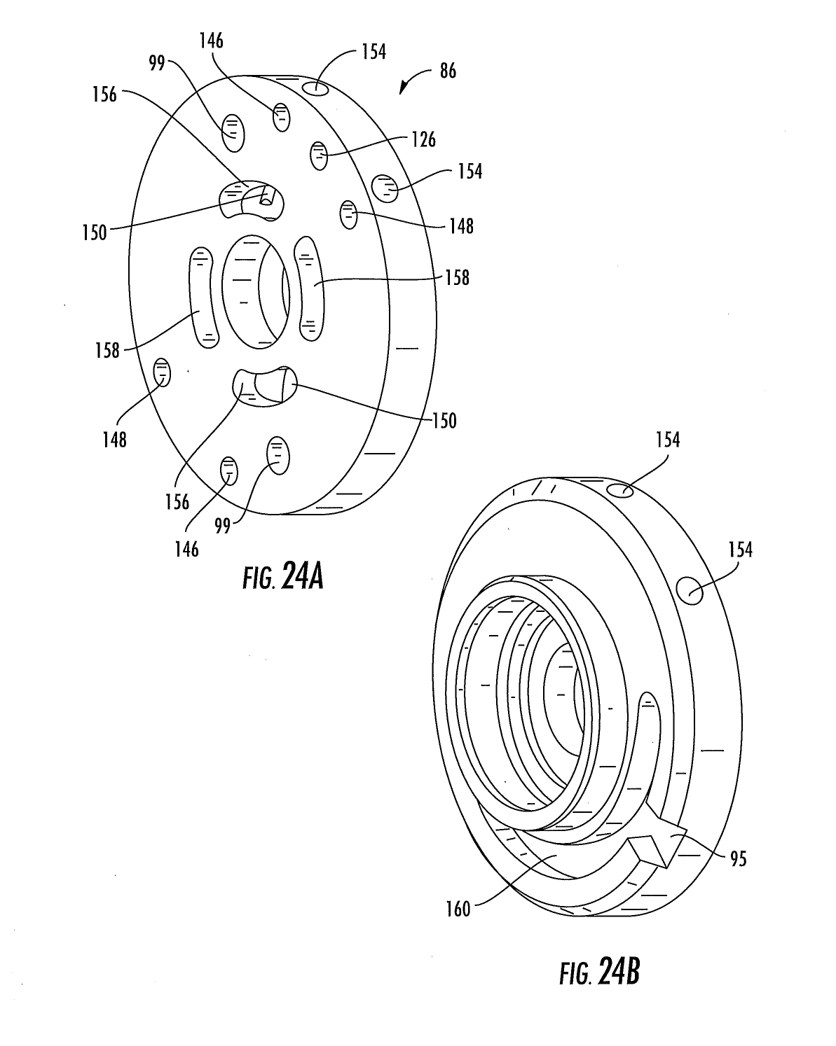

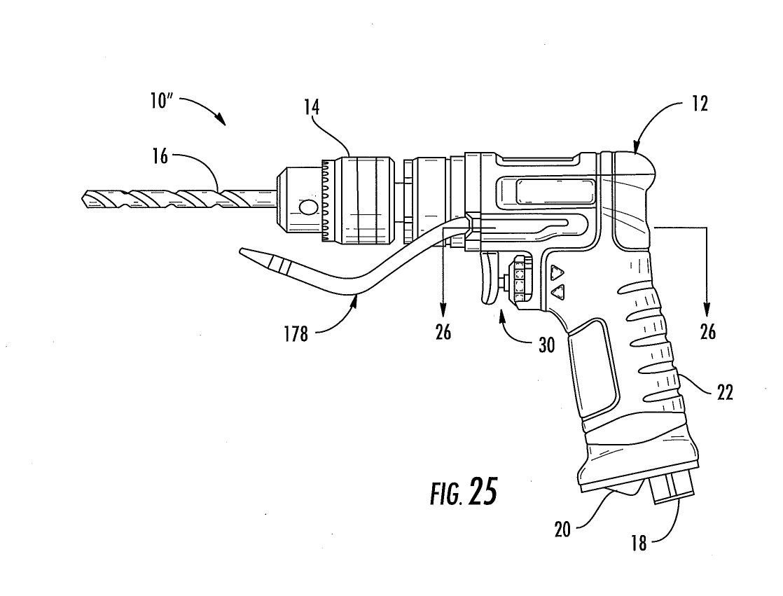

Referring now to FIGS. 23A-23F, and 24A and 24B, and particularly to FIGS. 23A, 23D, 23F and 24A, the pressurized air from the axially-extending air passages 142, 144 in the cylinder sleeve 82 enters the rear end plate 86 via short axial air inlets 146, 148, which in turn are in fluid communication with respective vertical air passages 150, 152 (which are plugged at 154 as shown in FIGS. 23D and 23F). The vertical air passages 150, 152 then feed the pressurized air into a corresponding number of radially-spaced, circumferentially-extending “banana” air slots 156, 158 (FIGS. 23A and 24A), which are so arranged with respect to the rotor 88 and air vanes 94 as to direct pressurized air to the junctions of the vanes with the rotor, thereby normally biasing the vanes radially outwardly from the rotor. The pressurized air from the banana slots 156, 158 also contributes to the volume that rotates the air vanes 94. Thus, pressurized air from the primary air throttle 32 enters the air chambers 96 of the air motor 80 of the present invention in two ways: radially, via the generally radial air inlets 138, 140 in the cylinder sleeve 82; and axially, via the banana slots 156, 158 in the rear end plate 86.

The rear end plate 86 of the air motor 80 of the present invention also receives air boost air 102 from the secondary air throttle 70, 70′, as described earlier. With reference to FIGS. 23A, 23B and 24B, that air boost air 120 is directed radially inwardly via a partial radial air passage 95, to a circumferentially-extending air channel 160. The partial radial air passage 95 and the circumferentially-extending air channel 160 are enclosed by the motor housing portion 28 of the housing 12. The channel 160 extends a circumferential distance of 180 degrees, and terminates in two radially-opposed axial air inlets 99, formed all the way through the rear end plate 86, and which direct boost air 102 into the motor air chambers 96.

After the pressurized air completes one drive cycle, it is exhausted to ambient atmosphere via two opposing pairs of radial exhaust ports 162 formed through the cylinder sleeve 82, as shown in FIGS. 22A-22G, which are in fluid communication with an annular exhaust air chamber 164 formed in the motor housing portion 28 and surrounding the cylinder sleeve 82, as shown for example in FIGS. 5 and 16. Now referring to FIGS. 5, 8A-8H, 9A-9E and 16, it is then conveyed as shown by arrows 166 around the primary air throttle 32 via exhaust channels 168, 170 formed in the forward-reverse valve 40 and the air throttle sleeve 50, respectively, and ultimately out of the bottom 70 of the tool handle 22 as previously described, the path described by the arrows 166 forming a primary air exhaust channel.

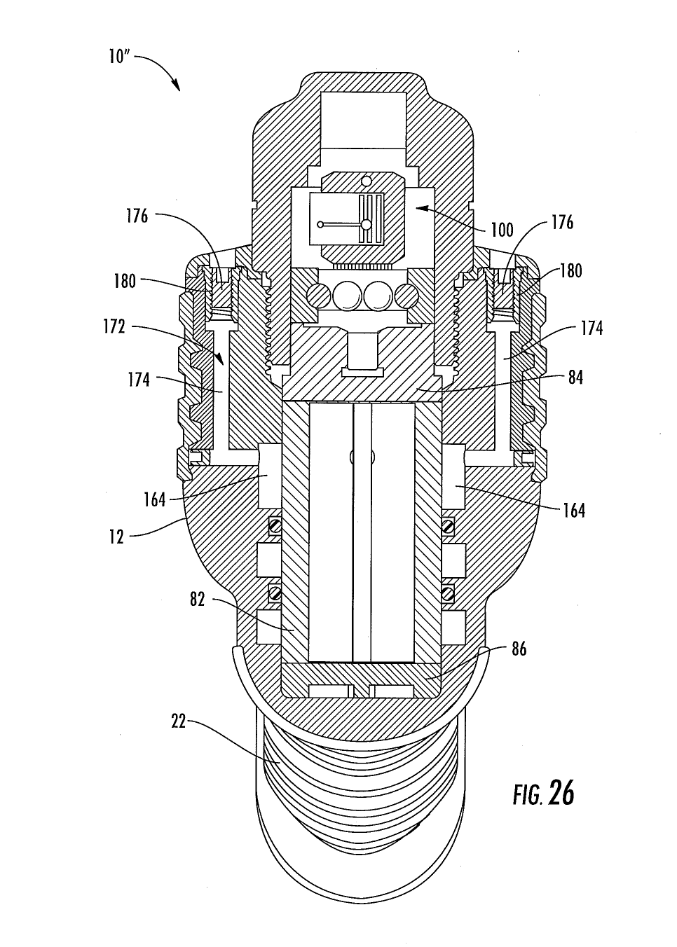

Yet another embodiment of the power tool 10″ of the present invention is illustrated in FIGS. 25 and 26, which show an auxiliary exhaust system 172 of the present invention. Referring to FIG. 26, part of the exhaust air from the annular exhaust air chamber 164 can be diverted into axially-extending interior auxiliary air passages 174 formed in the housing 12. These terminate in exterior auxiliary exhaust air ports, namely set screw plugs 176, which are selectively removable to allow a portion of the exhaust air to exit the tool 10″ near the front. As shown in FIG. 25, one or more axially-extending exterior tubes 178 may be attached to plug sockets 180, and may further be so configured as to direct a stream of exhaust air at the tip of the drill bit 16 to keep the drill bit and adjacent workpiece area clear of chips and dust.

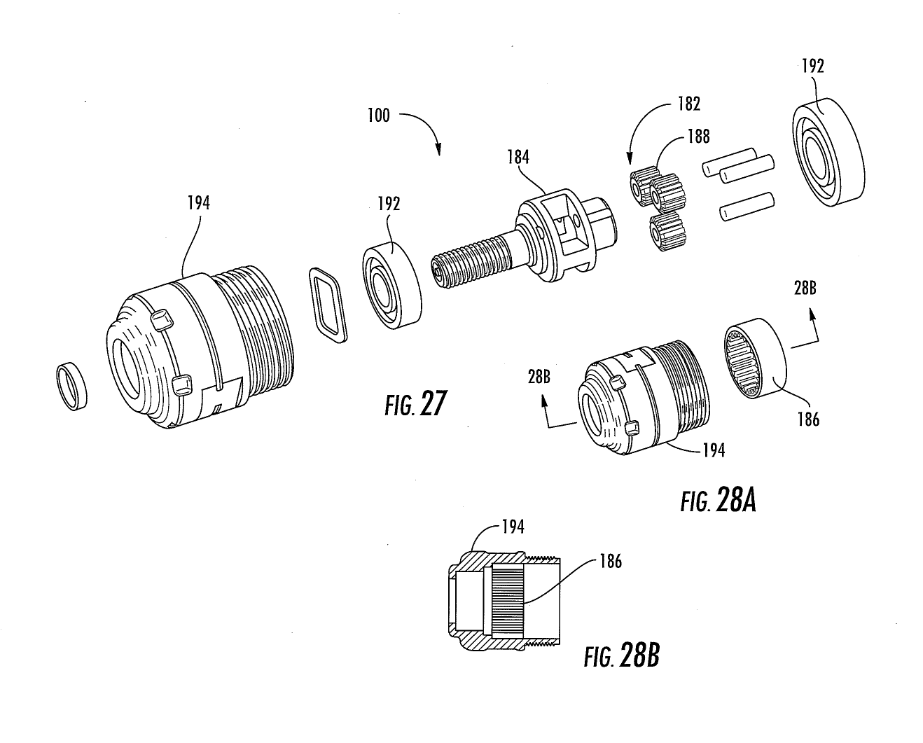

The last element of the power tool 10, 10′, 10″ of the present invention to be discussed is the compact drive system 100. As shown in FIGS. 5, 21, 27, 28A and 28B, the drive pinion portion 132 of the air motor rotor 88 is drivingly connected through a single-stage planetary gear system 182 to an output spindle/planet carrier 184. In the presently-described embodiments of the power tool 10, 10′ of the present invention, although a single-stage transmission is depicted, no gearing stages need be used, if desired, The single-stage planetary transmission 182 also includes a steel ring gear 186, inside of which three gears 188 rotate and which in turn drive the output spindle/planet carrier 184, which defines three cavities 190 to accept the gears. The compact drive system 100 is rotatably supported by bearings 192. Referring to FIGS. 28A and 28B, in this embodiment of the compact drive system 100 of the present invention, the ring gear 186 is assembled into a Titanium gear head housing 194, such as by shrink-fitting the two parts together.

The above-described embodiments are not to be construed as limiting the breadth of the present invention. Modifications and other alternative constructions will be apparent that are within the spirit and scope of the invention as defined in the appended claims.

What is claimed is:

1. A method for controlling a fluidically-driven power tool having an output member, comprising the steps of:
actuating a first stage of a multi-stage throttle-actuated dual-ported mechanism disposed in the power tool to drive the output member at a predetermined speed;
sensing an increase in resistance at the output member; and
selectively actuating a second stage of the mechanism to continue to drive the output member at the predetermined speed.

2. The method claimed in claim 1, wherein:
the power tool includes a fluidically-driven prime mover operatively associated with the output member;
the step of actuating the first stage includes admitting pressurized fluid into the prime mover via a first delivery path in fluid communication with one of the ports; and
the step of actuating the second stage includes admitting pressurized fluid into the prime mover via a second delivery path in fluid communication with the other port.

3. The method claimed in claim 2, wherein pressurized fluid is admitted into the prime mover via the second delivery path simultaneously with the pressurized fluid admitted into the prime mover via the first delivery path.

4. The method claimed in claim 3, wherein admitting pressurized fluid into the prime mover via the second delivery path augments the volume of pressurized fluid admitted into the prime mover via the first delivery path to thereby overcome the sensed increase in resistance at the output member.

5. The method claimed in claim 2, wherein:
the mechanism includes a primary throttle defining one of the ports, and a secondary throttle defining the other port;
the secondary throttle is axially aligned with the primary throttle; and wherein
actuating the second stage of the mechanism includes moving an actuator from a first axial position in which the primary throttle is open to a second axial position in which the secondary throttle is also open.

6. The method claimed in claim 2, wherein:
the mechanism includes a primary throttle defining an axis and further defining one of the ports, and a secondary throttle defining the other port;
the secondary throttle further defining an axis which is not axially aligned with the primary throttle axis; and further comprising
an actuator operatively associated with the primary and secondary throttles to selectively open the primary and secondary throttles.

7. The method claimed in claim 6, wherein the actuator is moveable along the primary throttle axis from a first axial position in which the primary throttle is opened to a second axial position in which the secondary throttle is opened.

8. The method claimed in claim 3, wherein the prime mover includes a fluidically-driven rotary motor.

9. The method claimed in claim 8, wherein the rotary motor is a rotary vane motor.

10. The method claimed in claim 9, wherein the rotary vane motor is a dual-chamber rotary vane motor.

11. The method claimed in claim 9, wherein the rotary vane motor is a dual-chamber rotary vane air motor and the pressurized fluid is air.

12. The method claimed in claim 3, wherein:
the prime mover is a fluidically-driven reciprocating piston system including an air chamber having a predetermined configuration and receiving pressurized fluid from the first and second delivery paths; and wherein
the power tool includes an impact mechanism operatively associated with the piston and the output member.

13. A method of rotatably driving a fastener into a workpiece using a power tool including a fluidically-driven motor, comprising the steps of:
admitting pressurized fluid into the motor via a first delivery path disposed in the power tool; and
upon sensing a change in resistance in the workpiece to driving the fastener, selectively also admitting air into the motor via a second delivery path to augment the volume of fluid delivered via the first delivery path; whereby the fastener may be driven without using a clutch mechanism operatively associated with the motor and the fastener.

14. A method for boosting the output speed and torque of a power tool driven by a fluidically-driven motor, comprising the steps of:
injecting pressurized fluid via a first delivery path into the motor; and
simultaneously injecting pressurized fluid into the motor via a second delivery path to augment the volume of pressurized fluid delivered to the motor.

15. The method claimed in claim 14, wherein the motor is a dual-chamber rotary vane air motor.

16. A method for conserving pressurized air delivered to a dual-chamber air motor disposed in a power tool having a tool element and connected to a source of air at a predetermined pressure, comprising the steps of:
actuating a first stage of a multi-stage throttle-actuated dual-ported mechanism disposed in the power tool to admit air at a predetermined volume into the motor via a first port in the mechanism; wherein
the first port is sized to restrict the volume of air flow into the motor so that the motor drives the tool element within a predetermined range of speed and torque; and
selectively actuating a second stage of the mechanism to admit air into the motor via a second port in the mechanism to augment the volume of air admitted into the motor by the first port.

17. The method claimed in claim 16, wherein:
air admitted via the first port is conveyed to the motor via a first delivery path; and
air admitted via the second port is conveyed to the motor via a second delivery path.

18. A method for driving the rotary output member of a fluidically-driven power tool having a motor, comprising the steps of:
connecting the power tool to a source of pressurized fluid;
actuating a primary throttle disposed in the power tool to admit fluid via a first delivery path into the motor to rotate the output member at a predetermined speed;
sensing a drop in the speed of the output member; and
actuating a secondary throttle disposed in the power tool to subsequently admit fluid via a second delivery path into the motor, to resume driving the output member at the predetermined speed, without having to increase the pressure of the fluid in the source of pressurized fluid.

19. The method claimed in claim 18, wherein:
the primary throttle includes a trigger;
actuating the primary air throttle includes the step of moving the trigger from a first predetermined axial position to a second predetermined axial position; and wherein
actuating the secondary throttle includes the step of moving the trigger from the second predetermined axial position to a third predetermined axial position.

20. A throttle system for a fluidically-powered power tool, comprising:
a fluidically-powered motor disposed in the power tool;
a primary throttle operatively associated with a secondary throttle and the motor;
the primary and secondary throttles being disposed in the power tool;
a source of pressurized fluid being connected to the primary and secondary throttles;
the primary throttle including a throttle sleeve defining an axis, and a primary throttle stem axially moveable in the throttle sleeve inwardly from a first predetermined axial position to a second predetermined axial position and to a third predetermined axial position, the stem being normally biased axially outwardly to the first predetermined axial position; wherein
in the first predetermined axial position, no pressurized fluid is admitted to the motor;
in the second predetermined axial position, pressurized fluid is admitted to the motor via a first delivery path; and wherein
in the third predetermined axial position, pressurized fluid is admitted to the motor from the secondary throttle via a second delivery path to augment the volume of pressurized fluid provided by the primary throttle.

21. The throttle system claimed in claim 20, wherein:
the primary throttle including a first valve; and
the secondary throttle including a second valve axially aligned with the first valve.

22. The throttle system claimed in claim 20, wherein:
the primary throttle including a first valve; and
the secondary throttle including a second valve defining an axis not disposed along the axis of the throttle sleeve.

23. The throttle system claimed in claim 20, wherein the primary throttle further comprising:
a forward-reverse valve coaxially disposed in the throttle sleeve;
a regulator coaxially disposed in the forward-reverse valve;
a regulator knob operatively associated with the regulator; and
a forward-reverse lever disposed axially inwardly of the regulator knob and being operatively associated with the forward-reverse valve.

24. The throttle system claimed in claim 23, wherein:
the regulator knob being operative to cause the regulator to selectively admit pressurized fluid to the motor at one of three different volumes.

25. The throttle system claimed in claim 23, further comprising:
a detent operatively associated with the forward-reverse valve and the throttle sleeve to releasably hold the forward-reverse lever in one of two predetermined circumferential positions.

26. The throttle system claimed in claim 20, wherein:
the primary throttle stem having an outer end and an inner end; and further comprising:
a trigger connected to the outer end and being actuatable by an operator;
a dual-rate compression spring assembly disposed about the primary throttle stem to normally resist the engagement by the operator; wherein:
the dual-rate compression spring assembly being so configured as to alert the operator by a sudden increase in resistance perceivable by the operator when the primary throttle stem approaches the third predetermined axial position.

27. The throttle system claimed in claim 20, wherein:
the primary throttle stem further being moveable to a fourth predetermined axial position intermediate the first and second predetermined axial positions; and wherein:
in the fourth predetermined axial position, a lower volume of pressurized fluid is admitted into the motor than is admitted in the second predetermined axial position.

28. The throttle system claimed in claim 20, wherein:
the source of pressurized fluid provides pressurized air, and the motor is an air-driven rotary motor;
the secondary throttle includes a tip valve assembly;
the tip valve assembly includes a tip valve bushing defining a longitudinal axis;
the tip valve bushing further defining a valve seat adjacent one axial end of the bushing and an air inlet adjacent the other axial end of the bushing;
the air inlet is operatively associated with the source of pressurized air;
the air outlet is operatively associated with the air-powered rotary motor;
the tip valve further including a tip valve member moveably disposed in the bushing, and having a head and a tip valve elongated stem;
the head being normally biased into sealing engagement with the valve seat, such that the tip valve elongated stem is normally substantially coaxial with the tip valve bushing axis;
the tip valve elongated stem being operatively associated with the primary air throttle stem; whereby
when the primary air throttle stem is moved to the third predetermined axial position, the primary air throttle stem engages the tip valve elongated stem to open the tip valve.

29. An air-driven power tool, comprising:
a housing including a motor portion, a drive system portion and a handle portion;
an air motor defining an axis and being mounted in the motor portion of the housing;
a drive system operatively associated with the motor and including an output spindle, the drive system being mounted in the drive system portion of the housing;
a throttle system operatively associated with the motor and mounted in the housing, and being connectable to a source of pressurized air;
an actuator moveably connected to the handle portion and being engageable by an operator; wherein
the actuator being operatively associated with the throttle system, such that when the actuator is moved from a first axial position to a second axial position relative to the handle portion, pressurized air is admitted into the motor via a first delivery path, and when the actuator is moved to a third axial position relative to the handle portion, pressurized air is also admitted into the motor, via a second delivery path, to augment the volume of air delivered to the motor via the first delivery path.

30. The power tool claimed in claim 29, wherein:
the motor including a cylinder sleeve having a front and a rear, a front end plate connected to the front of the cylinder sleeve, a rear end plate connected to the rear of the cylinder sleeve, a rotor rotatably disposed in the cylinder sleeve along the motor axis intermediate the plates; and a plurality of vanes radially moveably connected to the rotor about the axis; wherein
the cylinder sleeve and rotor defining an eccentric motor air chamber;
the cylinder sleeve defining a sleeve air inlet;
the rear end plate defining an end plate air inlet; and wherein,
when the actuator is in the second axial position, pressurized air is admitted to the motor via the sleeve air inlet, and when the actuator is in the third axial position, pressurized air is also admitted to the motor via the rear plate air inlet.

31. The power tool claimed in claim 30, wherein:
the cylinder sleeve and rotor defining two radially-opposing eccentric motor air chambers;
the sleeve defining two sets radially-opposed generally radial air inlets; and
the rear end plate defining two radially-opposed axial air inlets; wherein the opposing generally radial and axial air inlets convey pressurized air to the respective opposed eccentric air chambers.

32. The power tool claimed in claim 29, wherein the throttle system comprising:
a primary throttle mounted in the handle portion of the housing; and
a secondary throttle mounted in the housing; wherein:
the actuator opens the primary throttle to admit pressurized air to the motor when the actuator is in the first axial position, and wherein the actuator also opens the secondary throttle to admit pressurized air to the motor when the actuator is in the second axial position.

33. The power tool claimed in claim 32, wherein:
the secondary throttle includes a tip valve;
the actuator includes a trigger operatively associated with a trigger stem;
the trigger stem being axially moveable in the primary throttle to selectively open the primary throttle and to selectively open the tip valve responsive to an operator's actuation of the actuator; and wherein:
the trigger stem being normally biased to an axial position in which the primary and secondary throttles are closed.

34. The power tool claimed in claim 32, wherein:
the primary throttle including a first valve;
the secondary throttle including a second valve axially aligned with the first valve;
the actuator includes a trigger operatively associated with a trigger stem;
the trigger stem being axially moveable in the first valve to open the first valve and to subsequently open the second valve responsive to an operator's actuation of the actuator; and wherein:
the trigger stem being normally biased to an axial position in which the primary and secondary throttles are closed.

35. The power tool claimed in claim 32, wherein:
the primary throttle including a forward-reverse valve coaxially rotatably disposed in the throttle sleeve and a regulator coaxially disposed in the forward-reverse valve; wherein:
the throttle sleeve defining two circumferentially-spaced radial air passages in fluid communication with a source of pressurized air when the primary throttle is opened, wherein:
one of the two air passages being so located in the cylinder sleeve as to drive the motor in the forward direction; and wherein:
the other of the two radial air passages being so located in the cylinder sleeve as to drive the air motor in the reverse direction;
the forward-reverse valve defining a radial air passage operatively associated with the two throttle sleeve radial air passages; and further comprising:
a forward-reverse lever operatively associated with the forward-reverse valve to selectively rotate the forward-reverse valve radial air passage to align with one of the two circumferentially spaced radial air passages in the throttle sleeve to thereby drive the motor in either the forward or the reverse direction.

36. The power tool claimed in claim 35, wherein the two air passages in the throttle sleeve are circumferentially spaced about 60°.

37. The power tool claimed in claim 35, wherein:
the regulator defining two sets of three different-sized radial air passages in fluid communication with a source of pressurized air when the primary throttle is opened; and further comprising:
a regulator knob operatively associated with the regulator to rotate the regulator to selectively align one of said regulator radial air passages with the forward-reverse valve radial air passage, to thereby vary the speed of the motor, either in forward or reverse.

38. The power tool claimed in claim 30, further comprising:
an air inlet passage formed in the handle portion of the housing and connectable to a source of pressurized air for conveying pressurized air to the throttle system;
an air exhaust passage formed in the handle portion of the housing for conveying exhaust air from the motor to ambient atmosphere; wherein
the motor cylinder sleeve defining a plurality of exhaust ports in fluid communication with a motor air exhaust chamber formed in the motor portion of the housing around the motor;
whereby exhaust air from the motor is normally conveyed to the ambient atmosphere via the handle; and further comprising:
an interior auxiliary exhaust air passage formed in the tool housing for diverting a portion of the exhaust air from the motor air exhaust chamber axially forwardly; and
an exterior tube connected to the auxiliary exhaust air passage for directing the portion of the exhaust air towards a tool member drivingly connected to the output spindle.

39. A rotary air motor for an air-driven power tool, comprising:
a cylinder sleeve defining an axis and having a front and rear, and further defining a plurality of axial air passages extending from the front to the rear;
a front end plate connected to the front of the cylinder sleeve and to a front bearing;
a rear end plate connected to the rear of the cylinder and to a rear bearing;
a rotor rotatably mounted in the cylinder sleeve along the cylinder sleeve axis and disposed between the plates and further being rotatably connected to the bearings;
a plurality of air vanes radially moveably connected to the rotor; wherein the cylinder sleeve and rotor defining an eccentric motor air chamber;
the cylinder sleeve further defining a plurality of generally radial air inlets for admitting pressurized air having a predetermined volume into the motor air chamber, the generally radial air inlets being in fluid communication with respective axial air passages formed in the cylinder sleeve;
the rear end plate defining internal air passages for receiving the pressurized air from the axial air passages and for directing the air at the air vanes adjacent the rotor to bias the air vanes radially outwardly and to rotate the air vanes; and wherein
the rear end plate further defining an axial air boost inlet for admitting pressurized air into the motor air chamber to augment the volume of air admitted to the motor air chamber.

40. The motor claimed in claim 39, wherein:
the cylinder sleeve and rotor defining two radially-opposed eccentric motor air chambers;
the cylinder sleeve defining two sets of radially-opposed, generally radial air inlets;
the rear end plate defining two radially-opposed axial air boost inlets; whereby the opposing axial and radial air inlets convey pressurized air to the respective opposed eccentric air chambers.

41. The motor claimed in claim 40, further comprising two sets of radially-opposed air outlets formed in the cylinder sleeve for conveying exhaust air out of the motor air chambers.

42. A method for replacing a transmission stage of an air-powered power tool that drives a tool bit in a predetermined range of desired rotational speeds at a predetermined range of desired torque, comprising:
providing the power tool with a dual-chamber rotary air motor including two opposed eccentric air chambers, and further including a rotor defining a drive pinion;
providing the power tool with an air throttle to selectively admit a predetermined volume of pressurized air to the air chambers via a first delivery path and, upon actuation by an operator, to additionally simultaneously admit boost air to the air chambers via a second delivery path to augment the volume of pressurized air admitted to the air chambers via the first delivery path; whereby
the power tool is capable of delivering output power to the tool bit in ranges at least equivalent to those delivered by an air-powered power tool having the transmission stage, even when the tool bit encounters such resistance in a workpiece as would otherwise tend to cause the power tool to stall.

43. A method for minimizing the length and weight of an air-driven power tool for driving an output member, comprising:
drivingly connecting a dual chamber air motor to drive the output member at a predetermined speed;
providing a valve system in the power tool that is operatively associated with the air motor to selectively boost the volume of pressurized air delivered to the motor; wherein
the air motor includes a cylinder sleeve disposed between front and rear end plates; and wherein
pressurized air is admitted to the dual air chambers via inlets in the cylinder sleeve, and pressurized air is also selectively admitted to the air chambers via inlets in one of the end plates.

44. An air exhaust system for an air-driven power tool, comprising;
a housing including a motor portion, a drive system portion disposed axially forwardly of the motor portion, and a handle portion;
an air-driven motor drivingly connected to an output spindle and disposed within the motor portion and defining an air exhaust port;
a motor air exhaust chamber formed in the motor portion of the housing around the motor;
the motor air exhaust port being in fluid communication with the motor air exhaust chamber;
an interior primary exhaust air passage disposed in the housing in fluid communication with the motor air exhaust chamber for normally conveying exhaust air from the exhaust chamber to ambient atmosphere;
an interior auxiliary exhaust air passage formed in the drive portion of the housing and in fluid communication with the primary air exhaust passage for selectively diverting a portion of the exhaust air from the motor air exhaust chamber axially forwardly; and
an exterior auxiliary exhaust air port formed in the drive system portion of the housing and being in fluid communication with the interior auxiliary air passage.

45. The power tool claimed in claim 44, wherein;
the exterior auxiliary exhaust air port being normally closed so that no exhaust air is diverted from the motor air exhaust chamber; and wherein
when the exterior auxiliary air port is opened, a predetermined amount of exhaust air is diverted from the motor air exhaust chamber.

46. The power tool claimed in claim 45, further comprising:
a tube connected to the exterior auxiliary exhaust air port in its opened state for directing exhaust air towards a tool member connected to the output spindle; and wherein
the handle portion defining a part of the primary exhaust air passage.
